(19) United States
(12) Patent Application Publication
(10) Pub. No.: US 2025/0278948 A1
(43) Pub. Date: Sep. 4, 2025

(54) INFORMATION PROCESSING APPARATUS AND METHOD

(71) Applicant: TOYOTA JIDOSHA KABUSHIKI KAISHA, Toyota-shi Aichi-ken (JP)

(72) Inventors: Mitsuhiro MIURA, Toyota-shi Aichi-ken (JP); Yoshiaki TOMATSU, Toyoake-shi Aichi-ken (JP)

(73) Assignee: TOYOTA JIDOSHA KABUSHIKI KAISHA, Toyota-shi Aichi-ken (JP)

(21) Appl. No.: 19/062,737

(22) Filed: Feb. 25, 2025

(30) Foreign Application Priority Data
Feb. 29, 2024 (JP) 2024-029971

(51) Int. Cl. G06V 20/59; G06T 7/20; G06V 20/40; G06V 40/20

(52) U.S. Cl. CPC G06V 20/59; G06T 7/20; G06V 40/20; G06T 2207/30196; G06T 2207/30242; G06T 2207/30268; G06V 20/40

(57) ABSTRACT

A controller including at least one processor of an information processing apparatus determines whether a number of standing passengers in a vehicle exceeds a threshold or not. The controller identifies a number of passengers in the vehicle based on the moving image analysis of a cabin of the vehicle when the number of standing passengers is less than the threshold. The controller identifies the number of passengers in the vehicle based on a transition of the number of passengers boarding and alighting the vehicle determined by the moving image analysis at an entrance/exit of the vehicle when the number of standing passengers exceeds the threshold. The controller outputs identified information about the number of passengers in the vehicle.

### CROSS REFERENCE TO THE RELATED APPLICATION

This application claims the benefit of Japanese Patent Application No. 2024-029971, filed on Feb. 29, 2024, which is hereby incorporated by reference herein in its entirety.

### BACKGROUND

### Technical Field

This disclosure relates to an information processing apparatus and a method.

### Description of the Related Art

Japanese Patent Application Laid-open No. 2022-94724 discloses a monitoring system. In the monitoring system, captured images taken by a photographing unit that captures images of each cabin of multiple moving objects are acquired. In the monitoring system, based on the acquired images, the amount of movement of passengers present in each cabin of the multiple moving objects is obtained. In the monitoring system, based on the obtained amount of movement, the priority indicating the degree of necessity to monitor passengers is calculated. In the monitoring system, the subject to be displayed on a display device that sequentially switches and displays each cabin of the multiple moving objects at display switching times is determined based on the priority.

### SUMMARY

This disclosure aims to accurately grasp the number of passengers in a vehicle.

An information processing apparatus, according to the present disclosure, includes a controller comprising at least one processor configured to perform;
determining whether a number of standing passengers in a vehicle exceeds a threshold or not,
identifying a number of passengers in the vehicle based on the moving image analysis of a cabin of the vehicle when the number of standing passengers is less than the threshold,
identifying the number of passengers in the vehicle based on a transition of the number of passengers boarding and alighting the vehicle determined by the moving image analysis at an entrance/exit of the vehicle when the number of standing passengers exceeds the threshold, and
outputting identified information about the number of passengers in the vehicle.

According to this disclosure, it is possible to accurately grasp the number of passengers in a vehicle.

### BRIEF DESCRIPTION OF THE DRAWINGS

FIG. 1 is a diagram illustrates the outline structure of the monitoring system,

FIG. 2 demonstrates an example of the arrangement of cabins, entrances, and in-vehicle cameras within the vehicle,

FIG. 3 is a block diagram schematically illustrating an example of the functional configuration of the onboard device,

FIG. 4 is a diagram illustrating an example of the table configuration of boarding and alighting information retained in the boarding and alighting information database,

FIG. 5 is a flowchart of the first process executed by the controller, and

FIG. 6 is a flowchart of the second process executed by the controller.

### DESCRIPTION OF THE EMBODIMENTS

An information processing apparatus may specify the number of passengers (occupants) in a vehicle using a camera. Here, it is assumed that the information processing apparatus counts the number of passengers boarding and alighting from the vehicle through moving image analysis of the entrance/exit, and identifies the number of passengers in the vehicle according to the transition of the counted boarding and alighting numbers. In this case, the information processing apparatus analyzes a video moving image where boarding passengers and/or alighting passengers are captured at the entrance/exit of the vehicle.

At this time, there may be cases where the information processing apparatus cannot accurately recognize the boarding and alighting passengers, due to overlapping of captures of boarding passengers, alighting passengers, or boarding passengers and alighting passengers in the moving image. Furthermore, as the information processing apparatus analyzes the moving image where boarding and/or alighting passengers moving within the vehicle for boarding or alighting are captured, the accuracy in recognizing boarding and alighting passengers becomes lower than when analyzing the moving image where non-moving passengers are captured. However, this may cause errors in the number of boarding and number of alightinging passengers counted by the information processing apparatus, making it difficult to determine the precise number of passengers in the vehicle.

On the other hand, it is assumed that the information processing apparatus counts the number of passengers in the cabin through moving image analysis of the cabin, and identifies the counted number of passengers in the cabin as the number of passengers in the vehicle. At this time, passengers are restricted from frequently moving within the vehicle cabin. Therefore, the information processing apparatus is able to count passengers who are in a restricted movement state via moving image analysis of the cabin. This allows the information processing apparatus to identify a more accurate number of passengers than when identifying the number of passengers in the vehicle through moving image analysis of entrance/exit where moving boarding and alighting passengers are captured.

However, there may be a standing passenger in the room. When this happens, there could be instances where seated passengers are not captured on the moving image due to standing passengers being in front of them. Moreover, there are cases where standing passengers overlap each other in the moving image. Therefore, if there are many standing passengers, it is assumed that the error in the number of passengers counted in the cabin will become larger compared to when there are fewer standing passengers.

A controller including at least one processor of an information processing apparatus according to the present disclosure determines whether a number of standing passengers in a vehicle exceeds a threshold or not. Here, the threshold for the number of standing passengers is the value at which the error in the cabin count process of the vehicle's passengers based on the moving image analysis of the cabin is expected to increase. The controller of the information processing apparatus identifies a number of passengers in the vehicle based on the moving image analysis of a cabin of the vehicle when the number of standing passengers is less than the threshold. The controller identifies the number of passengers in the vehicle based on a transition of the number of passengers boarding and alighting the vehicle determined by the moving image analysis at an entrance/exit of the vehicle when the number of standing passengers exceeds the threshold. The controller outputs identified information about the number of passengers in the vehicle.

As described above, in the case where an increase in the error in the number of passengers counted in the cabin is expected due to the moving image analysis of the cabin, the information processing apparatus will determine the number of passengers according to the trend of the number of passengers boarding and disembarking counted by the moving image analysis of the entrance/exit. This enables the information processing apparatus to accurately identify the number of passengers in the vehicle more precisely than identifying the number of passengers by moving image analyses in the cabin.

Furthermore, when the error in the number of passengers counted by the moving image analysis in the cabin is not expected, the information processing apparatus identifies the number of passengers in the vehicle based on the number counted by the moving image analysis in the cabin. This allows the information processing apparatus to identify the number of passengers in the vehicle more accurately than identifying the number of passengers in a vehicle according to the number of boarders and alighting passengers counted by the video image analysis of the entrance/exit. By thus switching the method of determining the number of passengers according to whether the number of standing passengers exceeds the threshold, the information processing apparatus can accurately grasp the number of passengers.

Hereinafter, specific embodiments of the present disclosure will be described based on the drawings. The dimensions, materials, shapes, and relative arrangements of the components described in the embodiments are not intended to limit the technical scope of the present disclosure to those alone unless otherwise specified. Furthermore, the hardware configuration, module configuration, functions, etc., described in the embodiments are not intended to limit the technical scope of the disclosure to those alone unless otherwise specified.

### EMBODIMENT

### (System Overview)

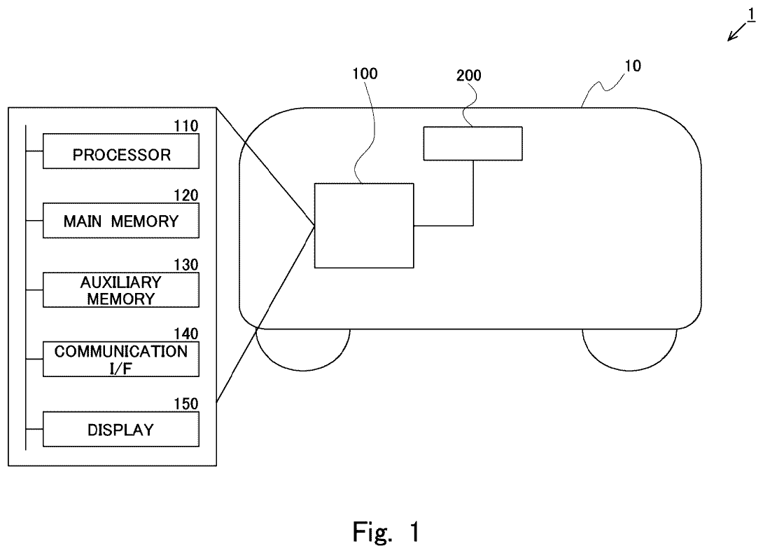

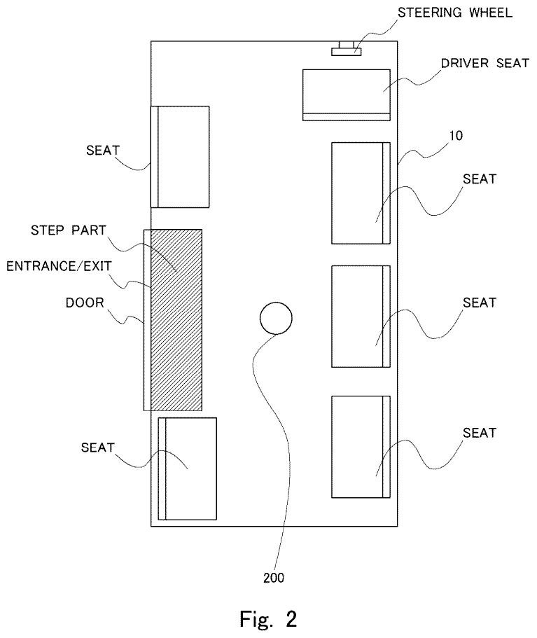

The monitoring system 1 in this embodiment will be described with reference to FIGS. 1 and 2. FIG. 1 is a diagram illustrating the outline of the monitoring system 1. The monitoring system 1 comprises an in-vehicle device 100 and an in-vehicle camera 200. In the monitoring system 1, the in-vehicle device 100 and the in-vehicle camera 200 are interconnected via an in-vehicle network. The in-vehicle device 100 and in-vehicle camera 200 are installed in the vehicle 10. In the present embodiment, the vehicle 10 is a bus. However, the vehicle 10 may be a vehicle other than a bus, as long as multiple passengers can board and disembark. A train car can be exemplified as the vehicle 10 other than a bus.

### (In-Vehicle Camera)

The in-vehicle camera 200 is an omnidirectional camera installed inside the vehicle 10. The in-vehicle camera 200 is equipped with a 360-degree fisheye lens. FIG. 2 is a diagram showing an example of the arrangement of the cabin, the entrance/exit, and the in-vehicle camera 200 in the vehicle 10. As shown in FIG. 2, passenger seats are provided in five locations in the passenger cabin of the vehicle 10. Also, the vehicle 10 is provided with a driver's seat. Also, on the side of the vehicle 10, there is entrance/exit for passengers to get on and off. Passengers board the vehicle 10 from the entrance/exit and move to the cabin, or move from the cabin to get off from the entrance/exit.

The in-vehicle camera 200 is installed in the center of the vehicle 10. In addition, the in-vehicle camera 200 is installed on the ceiling portion of the vehicle 10. In this way, the in-vehicle camera 200 captures moving images of the entire interior of the vehicle 10, including the cabin and the entrance/exit of the vehicle 10. The in-vehicle camera 200 transmits the moving images of the entire interior of the vehicle 10 to the in-vehicle device 100 real-time via the in-vehicle network.

### (In-Vehicle Device)

The in-vehicle device 100 is a device that identifies the number of passengers in the vehicle 10. The in-vehicle device 100 identifies the number of passengers in the vehicle 10 by analyzing the moving images captured by the in-vehicle camera 200 (hereinafter sometimes simply referred to as “motion images”). Specifically, the in-vehicle device 100 identifies the heads of the passengers captured in the moving image analysis and counts the number of identified heads.

Here, let us assume that the in-vehicle device 100 identifies the number of passengers getting on the vehicle 10 (hereinafter sometimes referred to as “number of boardings”) and the number of passengers getting off the vehicle 10 (hereinafter sometimes referred to as “number of alightings”) by analyzing the entrance/exit part in the motion images, and identifies the number of passengers in the vehicle 10 using the transition of the number of boardings and the number of alightings. Specifically, this situation assumes that the in-vehicle device 100 determines the number of passengers inside the vehicle 10 by subtracting the total number of alightinging passengers from the total number of boarding passengers.

The in-vehicle device 100 identifies the number of boardings and the number of alightings in the vehicle 10 by analyzing the moving images capturing the boarding passengers from the entrance/exit to the cabin or the disembarking passengers moving from the cabin to the entrance/exit. At this time, boarding passengers and alighting passengers, as well as boarding passengers themselves or alighting passengers themselves, may be overlapping in the moving images. In that case, there may be instances where the in-vehicle device 100 is unable to accurately recognize passengers getting on and off.

In addition, since the in-vehicle device 100 analyzes moving images of passengers moving for getting on and/or off the vehicle, the recognition accuracy of passengers getting on and off the vehicle decreases. At this time, there are cases where the in-vehicle device 100 may misidentify boarding passengers and alighting passengers. In other words, the in-vehicle device 100 may misidentify a boarding passenger as an alighting passenger or an alighting passenger as a boarding passenger. Specifically, in the vehicle 10 of this embodiment, since the same boarding and alighting entrance is used, boarding and alighting passengers might use the entrance/exit simultaneously. Therefore, it is easier for boarding and alighting passengers to pass each other and for passengers to be mistaken for one another compared to when separate boarding and alighting doors are provided in the vehicle 10. Therefore, these errors may also affect the boarding and/or number of alightings registered by the in-vehicle device 100, making it difficult to ascertain the exact number of passengers in vehicle 10.

In this embodiment, both boarding and alighting passengers use the same entrance/exit. However, separate entrances for boarding passengers and exits for alighting passengers may be provided on the vehicle 10.

On the other hand, assume that the in-vehicle device 100 performs a process of counting passengers in the cabin of the vehicle 10 by analyzing the cabin part in the moving image (hereinafter sometimes referred to as “cabin count process”). In this case, the in-vehicle device 100 specifies the number of passengers in vehicle 10 based on the count of passengers counted in the cabin by the cabin count process. At this time, passenger mobility within the cabin is restrained. Therefore, the in-vehicle device 100 is able to count passengers whose movement is limited during the moving image analysis. In other words, the in-vehicle device 100 can count passengers whose movement is less than boarding and alighting passengers. Therefore, the in-vehicle device 100 can count the number of passengers in the cabin more accurately than analyzing the entrance part of the moving image to count the number of passengers in the vehicle 10.

However, in the passenger cabin of vehicle 10, there may be standees present. In this case, if there are standing passengers in front of seated passengers (hereafter referred to as “seated passengers”), the seated passengers may not be captured in the cabin part of the moving images. Furthermore, when there are multiple standing passengers, overlapping standing passengers in the moving images may occur. Therefore, when there are many standees, it is assumed that the error in the cabin count process increases compared to when there are few standees.

Therefore, the in-vehicle device 100 executes a determination process to check if the number of standing passengers in the cabin exceeds a certain threshold. Here, the threshold number of standees is a value at which an increase in error in the cabin count process is expected. When the number of standing passengers is below this threshold, the in-vehicle device 100 specifies the number of passengers in vehicle 10 using the cabin count process. Furthermore, if the number of standing passengers is above the threshold, the in-vehicle device 100 specifies the number of passengers in vehicle 10 based on the transition of the count of boarding and alighting passengers by the count processing from moving image analysis at the entrance (hereafter referred to as “entrance/exit count process”). The in-vehicle device 100 then outputs this information as the number of passengers for vehicle 10 (hereafter referred to as “passenger count information”).

Moreover, the in-vehicle device 100 may also specify the number of passengers in vehicle 10 using the cabin count process even when the number of standing passengers exceeds the threshold. Additionally, at this time, the in-vehicle device 100 may identify the number of passengers in the vehicle 10 according to the transition of the number of boarding and alighting passengers counted by the boarding/exiting count process of the vehicle 10 when the number of standing passengers is less than the threshold. In this case, if the number of standing passengers matches the threshold, it is acceptable to execute either the process that determines the vehicle 10 passenger count by the onboard count processing or the process that determines the vehicle 10 passenger count based on the transition of boarding and alighting passenger counts by the entrance/exit count processing.

The in-vehicle device 100 includes a computer having a processor 110, a main memory 120, an auxiliary memory 130, a communication interface (communication I/F) 140, and a display 150. The processor 110 is, for example, a CPU (Central Processing Unit) or DSP (Digital Signal Processor). The main memory 120 is, for example, RAM (Random Access Memory). The auxiliary memory 130 is, for example, ROM (Read Only Memory). Additionally, the auxiliary memory 130 may be disk recording media such as HDD (Hard Disk Drive), CD-ROM, DVD disc, or Blu-ray disc. Furthermore, the auxiliary memory 130 may also be removable media (portable storage media). For example, USB memory or an SD card is exemplified as removable media. The communication I/F 140 is, for example, a LAN (Local Area Network) interface board or a wireless communication circuit for wireless communication. The display 150 is a display provided inside vehicle 10.

In the in-vehicle device 100, various programs, an operating system (OS), and various information tables are stored in the auxiliary memory 130. Moreover, in the in-vehicle device 100, various functions described later can be realized by the processor 110 loading and executing programs stored in the auxiliary memory 130 into the main memory 120. However, some or all of the functions in the in-vehicle device 100 may be realized by hardware circuits such as ASIC or FPGA. Additionally, the in-vehicle device 100 does not necessarily have to be realized by a single physical configuration and may be configured by multiple computers that work in coordination with each other. The in-vehicle camera 200 is also configured to include a computer similarly to the in-vehicle device 100.

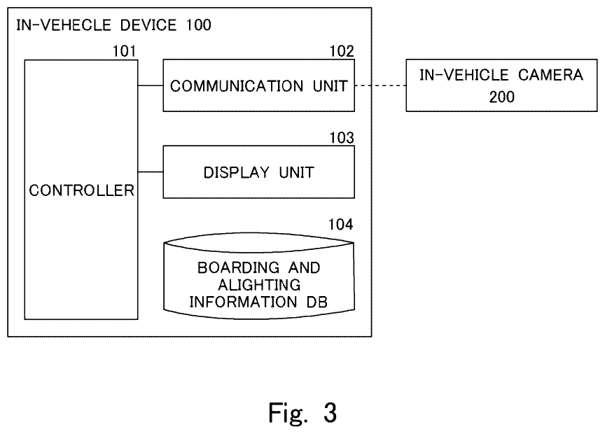

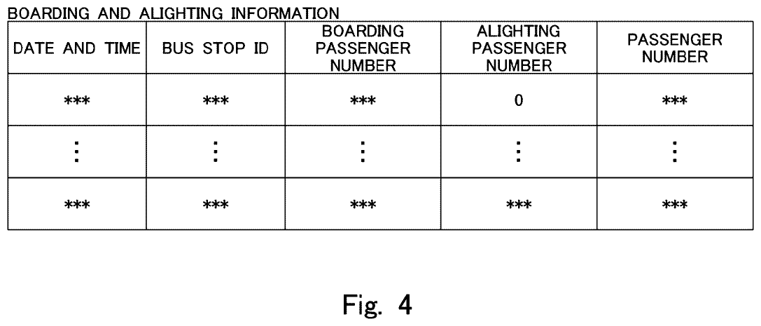

Next, the functional configuration of the in-vehicle device 100 that constitutes the monitoring system 1 according to this embodiment will be described based on FIG. 3 and FIG. 4. FIG. 3 is a block diagram schematically showing an example of the functional configuration of the in-vehicle device 100. The in-vehicle device 100 comprises a controller 101, a communication unit 102, a display unit 103, and an boarding and alighting information database 104 (boarding and alighting information DB 104). The controller 101 has a function to perform arithmetic processing for controlling the in-vehicle device 100. The controller 101 can be realized by the processor 110 in the in-vehicle device 100. The communication unit 102 has a function to connect the in-vehicle device 100 to the in-vehicle network. The communication unit 102 can be realized by the communication I/F 140 in the in-vehicle device 100.

The controller 101 acquires the moving images inside the vehicle 10 from the in-vehicle camera 200 in real-time through the communication unit 102. The controller 101 executes the entrance/exit count process by referring to the acquired moving images. Specifically, by analyzing the entrance portion of the moving images, the controller 101 identifies boarders and alighters. At this time, the controller 101 recognizes the person moving from the entrance-exit of the vehicle 10 into the vehicle 10 as a boarder. Also, the controller 101 recognizes the person moving outside the vehicle 10 from the entrance of the vehicle 10 as an alighter. The controller 101 counts the number of boarding and disembarking passengers by recognizing boarding and alightinging passengers. The controller 101 stores the counted boarding and alighting passenger numbers in the boarding and alighting information DB 104. The controller 101 executes the entrance/exit count process at the timing when the vehicle 10 stops at a bus stop for passengers to board and alight.

The boarding and alighting information DB 104 functions to retain boarding and alighting information. The boarding and alighting information relates to the transition of boarding and alighting passenger numbers. The boarding and alighting information DB 104 can be realized by the auxiliary memory 130 in the in-vehicle device 100. FIG. 4 shows an example of a table structure of the boarding and alighting information held in the boarding and alighting information DB 104.

As illustrated in FIG. 4, the boarding and alighting information includes a date and time field, a bus stop ID field, a boarding passenger number field, an alighting passenger number field, and a passenger number field. The date and time field stores information to specify the date and time. The date and time field stores the date and time when vehicle 10 stops at a bus stop. The bus stop ID field stores an identifier (bus stop ID) for identifying the bus stop at which vehicle 10 stops at the specified date and time field. The boardings passenger number field stores information indicating the number of boardings at the date and time in the corresponding date and time field. Also, the alighting passenger number filed stores information indicating the number of alightinging off at the date and time corresponding to the date and time field.

The boarding and alighting information illustrated in FIG. 4 is the information on the boarding and alighting passenger numbers during the period from when the vehicle 10 stops at the first bus stop until it stops at the most recent bus stop. At the time when vehicle 10 stops at the first bus stop, there are no passengers alighting from vehicle 10. Therefore, the alighting passenger number field corresponding to the earliest date and time (the date and time the vehicle 10 first stopped at the bus stop) in the boarding and alighting information will store “0”.

The passenger count field stores information indicating the number of passengers, calculated based on the transition of the number of boarding and alighting passenger. The controller 101 calculates the sum of all the number of boardings in the boarding passenger number field. In other words, the controller 101 calculates the total number of boardings from when the vehicle 10 stopped at the first bus stop to the current time. Also, the controller 101 calculates the sum of all alighting passenger number fields. In other words, the controller 101 calculates the total number of alighting passengers who have alighted since the vehicle 10 stopped at the first bus stop until now.

Here, the value obtained by subtracting the total number of alighting passengers from the total number of boarding passengers matches the number of passengers currently remaining in vehicle 10. Therefore, the controller 101 can calculate the current number of passengers in the vehicle 10 by a calculation process that subtracts the sum of all alighting passenger fields from the sum of all boarding passenger number fields. The controller 101 stores the information indicating the calculated current number of passengers in vehicle 10 in the passenger count field.

In addition, the controller 101 counts the number of standing passengers by analyzing the passenger compartment part of the moving image received from the in-vehicle camera 200. Here, the controller 101 identifies passengers located in positions other than the seats as standees and counts the number of standing passengers. The controller 101 then executes a determination process to check whether the number of standing passengers exceeds the threshold.

If the number of standing passengers is equal to or above the threshold, an increase in the error of the cabin count process, as described above, is expected. Therefore, if the number of standing passengers is equal to or above the threshold, the controller 101 specifies the number of passengers calculated by the calculation process as the current number of passengers in vehicle 10. If the number of standing passengers is below the threshold, it is expected that the error in the cabin count process will not increase. Therefore, when the number of standing passengers is less than the threshold value, the controller 101 specifies the number of passengers from the cabin count process as the current number of passengers in vehicle 10.

The display unit 103 has the function of displaying various information to the driver of vehicle 10. The display unit 103 can be realized by the display 150 in the in-vehicle device 100. The controller 101 outputs (sends) the passenger count information to the display unit 103 via the communication unit 102. The display unit 103 displays the passenger count information received from the controller 101 to the driver of the vehicle 10. As a result, the driver of the vehicle 10 can grasp the number of passengers in vehicle 10.

Here, during the time period when the vehicle 10 is crowded (hereinafter referred to as “peak hours”), there are more passengers in the cabin compared to non-peak times. Therefore, during peak hours, there may be a greater error in the cabin count process compared to non-peak hours. Furthermore, during peak hours, it is expected that the number of passengers boarding and number of alighting will increase compared to when vehicle 10 is not crowded. Therefore, during crowded times, the error in the entrance/exit count process may be larger than during non-crowded times. As a result, the error in the passenger count information indicating the number of passengers in vehicle 10 increases.

Therefore, the controller 101 may output the notification information along with the passenger count information to the display unit 103 via the communication unit 102 during peak hours. Here, the notification information is information that prompts the driver of the vehicle 10 to visually confirm the number of passengers. As a result, the exact number of passengers in the vehicle 10 is counted by the driver of the vehicle 10.

### (First Process)

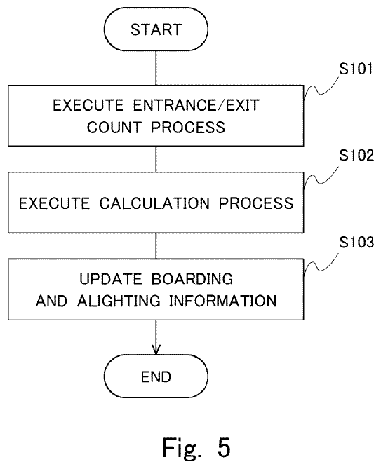

Regarding the first process executed by the controller 101 of the in-vehicle device 100 the monitoring system 1, it will be explained based on FIG. 5. FIG. 5 is a flowchart of the first process executed by the controller 101. The first process is to update the boarding and alighting information. The first process is executed when the vehicle 10 arrives at a bus stop for passengers to board and alight.

In the first process, first, in S101, by analyzing the entrance part in the moving image, the entrance/exit count process is executed. The entrance/exit count process is executed until the boarding and exiting of the passengers of the vehicle 10 is completed. The entrance/exit count process is executed, for example, during the time the door of the vehicle 10 is open and then closed.

Next, in S102, the calculation process is executed. Specifically, the number of boarding and alighting passengers counted by the entrance/exit count process, as well as the past numbers of boarding and alighting passengers in the boarding and alighting information held in the boarding and alighting information DB 104, are referenced to calculate the number of passengers in vehicle 10. Next, in S103, the number of boarding and alighting passengers counted by the entrance/exit count process, and the calculated number of passengers, are newly recorded in the boarding and alighting information in the boarding and alighting information DB 104, which then updates the boarding and alighting information. Then the first process is completed.

### (Second Process)

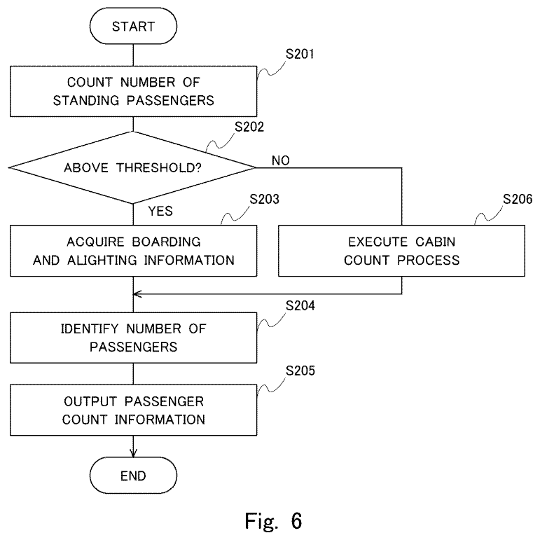

Regarding the second process executed by the controller 101 of the in-vehicle device 100 the monitoring system 1, it will be explained based on FIG. 6. FIG. 6 is a flowchart of the second process executed by the controller 101. The second process is a process for the controller 101 to output passenger count information. The second process is executed, for example, when the vehicle 10 departs after stopping at a bus stop for passengers to board and alight. Additionally, the second process may be executed after a predetermined amount of time has passed since the vehicle 10 departed from the bus stop where it stopped to allow passengers to board and alight. This allows the second process to be executed after the passengers have completely moved within the vehicle 10.

In the second process, first in S201, the cabin part of the moving image is analyzed, and the number of standing passengers is counted. Next, in S202, it is determined whether the standing passenger count is above the threshold. If an affirmative determination is made in S202, there is a higher possibility of error in the passenger count due to the cabin count process compared to a negative determination in S202.

Therefore, if a positive determination is made in S202, the boarding and alighting information is retrieved from the boarding and alighting information DB 104 in S203. Next, in S204, the number of passengers in the field corresponding to the latest date and time field in the boarding and alighting information is identified as the number of passengers on vehicle 10. In this manner, the number of passengers in vehicle 10 is calculated based on the transition of the number of passengers boarding and number of alighting as counted by the entrance/exit count process. Next, in S205, the passenger count information for the specified number of passengers in the vehicle 10 is output to the display unit 103. Then the second process is completed.

On the other hand, if a negative determination is made in S202, there is a lower possibility of error in the passenger count due to the cabin count process compared to an affirmative determination in S203. Therefore, in S206, the cabin count process is executed. Next, in S204, the number counted by the cabin count process is specified as the number of passengers in the vehicle 10. Next, in S205, the passenger count information for the specified number of passengers is output to the display unit 103. Then the second process is completed.

As explained above, in the monitoring system 1, if the increase in monitoring errors for passenger count is expected due to the standing passenger count being above the threshold, the number of passengers calculated by the calculation processing will be taken as the passenger count of the vehicle 10, and the passenger count information will be output. As a result, it can output more accurate passenger information than the cabin count process. In addition, if an increase in the error of the cabin count process is not expected because the number of standing passengers is less than the threshold, the number of passengers in the cabin counted by the cabin count process will be output as the number of passengers in the vehicle 10. This allows more accurate passenger information to be output than the calculation process.

In this embodiment, one in-vehicle camera 200 is provided in the vehicle 10. Then, there are cases where parts that the in-vehicle camera 200 cannot image occur. Therefore, compared to the case where multiple in-vehicle cameras 200 are provided inside the vehicle 10, the counting error in the cabin count process and the counting error in the entrance/exit count process tend to occur more easily. Therefore, in the monitoring system 1, depending on whether the number of standing passengers exceeds the threshold or not, a method for identifying the number of passengers in the vehicle 10, which would generate fewer errors, is selected, so more accurate passenger information can be output. As a result, the driver of the vehicle 10 can accurately grasp the number of passengers in the vehicle 10.

### Modified Example 1

In the present embodiment, the in-vehicle device 100 executes the determination process of whether the identified number of standing passengers exceeds the threshold. On the other hand, in this modified example, the in-vehicle device 100 executes the determination process of whether standing passengers are present. In other words, in this modified example, the in-vehicle device 100 executes the determination process of whether the identified number of standing passengers exceeds 1 (threshold 1). At this time, in the cabin, all passengers of the vehicle 10 are seated. Therefore, in the cabin part of the moving image, all passengers are seated passengers. As a result, there is no overlapping of standing passengers with seated passengers in the moving image. Even if seated passengers are sitting side by side, their heads are sufficiently apart, thus preventing the heads of seated passengers from overlapping in the moving image. Therefore, the error in the cabin count process is the least likely to occur. Therefore, setting the threshold for the number of standing passengers to 1 makes it possible to execute the most accurate cabin count process. As a result, the driver of vehicle 10 can accurately grasp the number of passengers in vehicle 10.

### Modified Example 2

In this embodiment, the vehicle 10 is a vehicle driven by a driver. However, the vehicle 10 may be an autonomous vehicle without a crew member. In this case, if the passenger count by the in-vehicle device 100 is not performed, personnel to count the number of passengers (hereinafter sometimes referred to as “counting personnel”) would be required. Here, the counting personnel boards the vehicle 10 to count the number of passengers. In addition, the counting personnel may count the number of passengers by remotely monitoring the moving image captured by the in-vehicle camera 200. However, since it is possible to accurately determine the number of passengers with the in-vehicle device 100, there is no need to provide counting personnel. Therefore, the in-vehicle device 100 can accurately grasp the current number of passengers while suppressing labor costs.

In this modified example, the in-vehicle device 100 outputs (transmits) the passenger count information to an external server that manages the number of passengers of the vehicle 10 via a global public communication network such as the Internet (WAN [Wide Area Network]) or a telephone communication network such as that for mobile phones. As a result, administrators of external servers can accurately grasp the number of passengers in the vehicle 10.

### Modified Example 3

In this embodiment, the in-vehicle device 100 counts the number of standing passengers by analyzing the moving image of the cabin area. However, the in-vehicle device 100 may acquire the number of standing passengers by other methods. For example, the in-vehicle device 100 may acquire the number of standing passengers according to the detection result of a human sensor that detects the people present in the standing area in the cabin of the vehicle 10.

### Modified Example 4

The monitoring system 1 can be used in various situations. The monitoring system 1 may be used to provide MaaS (Mobility as a Service), which is a service utilizing mobility.

### Other Embodiments

The embodiments described above are merely examples, and the present disclosure can be appropriately changed and implemented without departing from the gist. Also, the processes and elements described in the present disclosure can be freely combined and implemented as long as there is no technical contradiction.

The processes described as performed by a single device may be executed divided among multiple devices. Alternatively, the processes described as performed by different devices may be executed by a single device. In a computer system, how each function is realized by hardware configuration (server configuration) can be flexibly changed.

The present disclosure can also be realized by providing a computer with a computer program that implements the functions described in the above embodiments so that one or more processors of the computer read and execute the program. Such a computer program may be provided to the computer through a non-volatile computer-readable storage medium that is connectable to the computer's system bus or may be provided to the computer via a network. A non-transitory computer-readable storage medium includes any type of medium suitable for storing electronic instructions, such as, for example, any type of disk, such as a magnetic disk (such as a floppy disk or a hard disk drive (HDD)), an optical disk (such as a CD-ROM, a DVD disk, or a Blu-ray disk), a read-only memory (ROM), a random-access memory (RAM), an EPROM, an EEPROM, a magnetic card, a flash memory, or an optical card.

What is claimed is:

1. An information processing apparatus including a controller comprising at least one processor configured to perform;
determining whether a number of standing occupants in a vehicle exceeds a threshold or not,
identifying a number of occupants in the vehicle based on the moving image analysis of a cabin of the vehicle when the number of standing occupants is less than the threshold,
identifying the number of occupants in the vehicle based on a transition of the number of occupants entering and exiting the vehicle determined by the moving image analysis at an entrance/exit of the vehicle when the number of standing occupants exceeds the threshold, and
outputting identified information about the number of occupants in the vehicle.

2. An information processing apparatus including a controller comprising at least one processor configured to perform;
determining whether a number of standing passengers in a vehicle exceeds a threshold or not,
identifying a number of passengers in the vehicle based on the moving image analysis of a cabin of the vehicle when the number of standing passengers is less than the threshold,
identifying the number of passengers in the vehicle based on a transition of the number of passengers boarding and alighting the vehicle determined by the moving image analysis at an entrance/exit of the vehicle when the number of standing passengers exceeds the threshold, and
outputting identified information about the number of passengers in the vehicle.

3. The information processing apparatus according to claim 2, wherein
determining whether the number of standing passengers exceeds the threshold or not is constituted by determining whether there exist any standing passengers or not.

4. The information processing apparatus according to claim 2, wherein
a single entrance/exit is provided in the vehicle.

5. The information processing apparatus according to claim 2, wherein
the moving image captured by a single camera that simultaneously shoots the cabin and the entrance/exit of the vehicle is used, in the moving image analysis of the cabin and the moving image analysis of the entrance/exit.

6. The information processing apparatus according to claim 2, wherein the vehicle is a self-driving vehicle with no crews onboard.

7. A method by the at least one processor of the information processing apparatus according to claim 2, for improving travel mobility as a service (Maas).
